(19) United States
(12) Patent Application Publication
(10) Pub. No.: US 2005/0030915 A1
(43) Pub. Date: Feb. 10, 2005

(54) Multi-band cellular service over direct broadcasting service (dbs) network

(76) Inventors: Harel Golombek, Netanya (IL); Mordechai Zussman, Kiriat Bialik (IL)

Correspondence Address: SUGHRUE MION, PLLC, 2100 PENNSYLVANIA AVENUE, N.W., SUITE 800, WASHINGTON, DC, 20037, US

(21) Appl. No.: 10/497,588

(22) PCT Filed: Jan. 2, 2002
(86) PCT No.: PCT/US02/00478

Related U.S. Application Data
(60) Provisional application No. 60/335,804, filed on Dec. 5, 2001.

(51) Int. Cl. H04B 7/185

(52) U.S. Cl. 370/316

(57) ABSTRACT

A DBS distribution network (100, 90) is modified with a secondary transmission bi-directional capability below 950 MHz by adding filters to separate modified mobile-communications (60) frequencies from typical DBS services. DBS subscriber termination points function as extremely localized ultra-miniature cell sites within a building. Third generation (3G) cellular networks and second-generation (2G) cellular networks are together merged with DBS networks. The modified network simultaneously handles traffic in known and future cellular air interface standards such as: UMTS, GSM, TDMA, CDMA. Cellular mobile radio terminals do not have to be modified. Signals traverse on non-utilized DBS frequencies. DBS active elements are modified, and new components are provided.

### CROSS-REFERENCE TO RELATED APPLICATIONS

This application claims the benefit of U.S. Provisional Application No. 60/335,804, filed Dec. 5, 2001, which is incorporated by reference, herein, in its entirety.

### BACKGROUND

1. Field of the Invention

This description relates to a new system and topology for providing cellular service in multiple bands by using the coaxial portion of a Direct Broadcasting Service (DBS) network infrastructure. In particular, this description relates to using DBS to extend mobile radio networks. Networks to which the description relates include, but are not limited to, UMTS, GSM, PCS, CDMA, TDMA, and PDC type networks.

2. Description of Related Art

FIG. 1 shows a mobile terminal 10 inside a building 5 making a mobile telephone call through a mobile radio/cellular network 60. In particular, the mobile radio 10 communicates with an antenna 20 located outside of the building 5. The antenna is controlled by a base transceiver station 30, which is controlled, in turn, by a mobile switching center 40. The mobile switching center 40 has a link with the public switched telephone network 50.

The basic theory by which mobile radio and cellular networks operate is well known. Geographically distributed network access points, each defining cells of the network, characterize cellular radio networks. The geographically distributed network access points are typically referred to as base stations BS or base transceiver stations BTS, and includes transmission and reception equipment for transmitting signals to and receiving signals from mobile radio terminals (MT).

Each cell (or sector) is using only part of the total spectrum resources licensed to the network operator, but the same capacity resources (either frequency or code), may be used many times in different cells, as long as the cell to cell interference is kept to a well defined level. This practice is known as the network reuse factor. The cells may be subdivided further, thus defining microcells. Each such microcell provides cellular coverage to a defined (and usually small) area. Microcells are usually limited in terms of their total available capacity.

The overall demand for both indoor and outdoor mobile services had caused cellular network operators to develop an intensive network of BTSs in urban areas. This has improved spectrum utilization (increased network capacity) at ground level, but has aggravated the problem in high-rise buildings where MTs 10 may now ‘see’ several BTSs (20, 30) on the same frequency or code. Overcoming this problem is an important aim of this system.

Cells in a cellular radio network are typically connected to a higher-level entity known as Mobile Switching Center (MSC) 40, which provides certain control and switching functions for all the BTSs 30 connected to it. All MSCs 40 are connected to each other, and also to the public switched telephone network (PSTN) 50, or may themselves have such a PSTN interface.

The conventional implementation of mobile radio networks has had some important limitations. When operating above 1 GHz, it is necessary in a conventional mobile radio network to build numerous base stations to provide the necessary geographic coverage and to supply enough capacity for high-speed data applications. The base stations require an important amount of real estate, and are very unsightly.

Another limitation is that, since cellular towers are expensive, and require real estate and costly equipment, it is economically feasible to include in a network only a limited number of them. Accordingly, the size of cells might be quite large, and it is therefore necessary to command the mobile radio terminals to radiate at high-power so as to transmit radio signals, strong enough for the geographically dispersed cellular towers to receive.

As the cell radius becomes larger, the average effective data rate per user in most packet based protocols decreases accordingly and the high-speed data service might deteriorate.

Yet another limitation to cellular radio networks as conventionally implemented is that the cellular antennas are typically located outside of buildings, even though it would be highly beneficial to provide cellular service inside buildings. The penetration of cellular signals for in-building applications requires high power sites, or additional sites or repeaters to overcome the attenuation inherent with in-building penetration. As frequency increases, the in-building signal level decreases accordingly.

Because the base station antennas 20 are usually located outside of buildings 5, it is difficult for mobile radio terminals 10 to transmit signals strong enough to propagate effectively from inside of the building 5 to outside of the building. Therefore, the use of mobile terminals 10 inside buildings 5 results in reduced data rate and consumes substantial amount of the limited battery time.

Yet another limitation of UMTS, GSM900, GSM1800, PCS1900, TDMA800, CDMA800 or PDC radio networks as conventionally implemented is the inherent limited capacity of each and every BTS 30 to provide voice and data service. This capacity shortage is due to the way the spectrum resources are allocated to each BTS 30.

To provide for reasonable voice & data quality, each BTS can use only a part of the total spectrum resources owned by the cellular operator. Other BTSs could reuse the same part of the spectrum resources as a given BTS, but a pattern of geographic dispersion would have to be respected. This is called a code reuse factor for CDMA based technologies, and a frequency reuse factor for TDMA based technologies.

Many buildings today are provided with a direct broadcast satellite service (DBS) as shown in FIG. 2. In FIG. 2, the building 5 is, perhaps, an apartment building or the like. The television sets 70 in the building 5 are connected through a DBS cable system 80 (not to be confused with “cable TV”) to a DBS antenna 90. The DBS antenna 90 receives DBS programming (i.e., television programs) directly from a satellite 100.

The DBS cable system 80 may have a variety of active components such as amplifiers 105. The DBS cable system 80 may be referred to as an access section of a DBS network because it provides access for the television sets 70 to the DBS programming.

The DBS system shown in FIG. 2 is useful for receiving television programming, but has never been used before to help solve the problems such as those mentioned above with respect to the user of the mobile terminal 10.

### BRIEF SUMMARY OF THE INTERVENTION

To overcome or mitigate the above-identified disadvantages of mobile radio networks, the invention provides for the use of access section of a DBS network for the benefit of the cellular radio network.

By carrying the mobile radio signals to the mobile subscriber's premises, by using the DBS network cabling, the reuse factor is reduced and the network's available capacity is increased by an order of magnitude. This is due to the fact that the propagation conditions are greatly improved by using the DBS as an access path inside buildings, instead of transmitting from outdoor towers.

The need for such a system is great, as can be seen from the above-identified deficiencies of the current mobile networks vis-\grave{a+EE-VIS indoor users.}

The invention is taught below by way of various specific exemplary embodiments explained in detail, and illustrated in the enclosed drawing figures.

### BRIEF DESCRIPTION OF THE DRAWINGS

The drawing figures depict, in highly simplified schematic form, embodiments reflecting the principles of the invention. Many items and details that will be readily understood by one familiar with this field have been omitted so as to avoid obscuring the invention. In the drawings:

FIG. 1 shows a conventional approach to using a mobile radio inside a building.

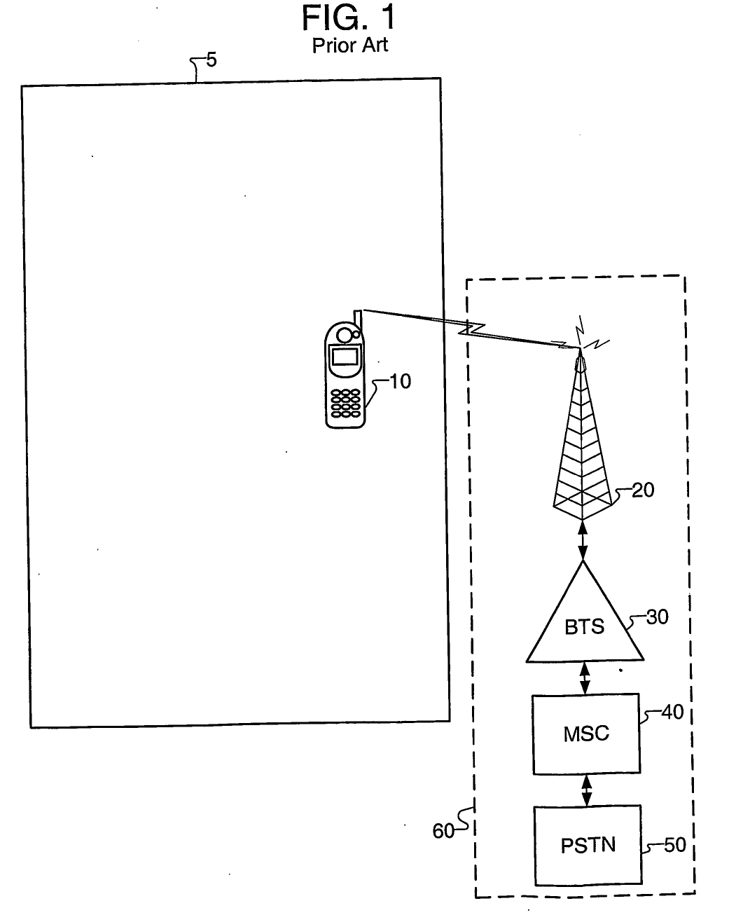

FIG. 2 shows a conventional DBS system.

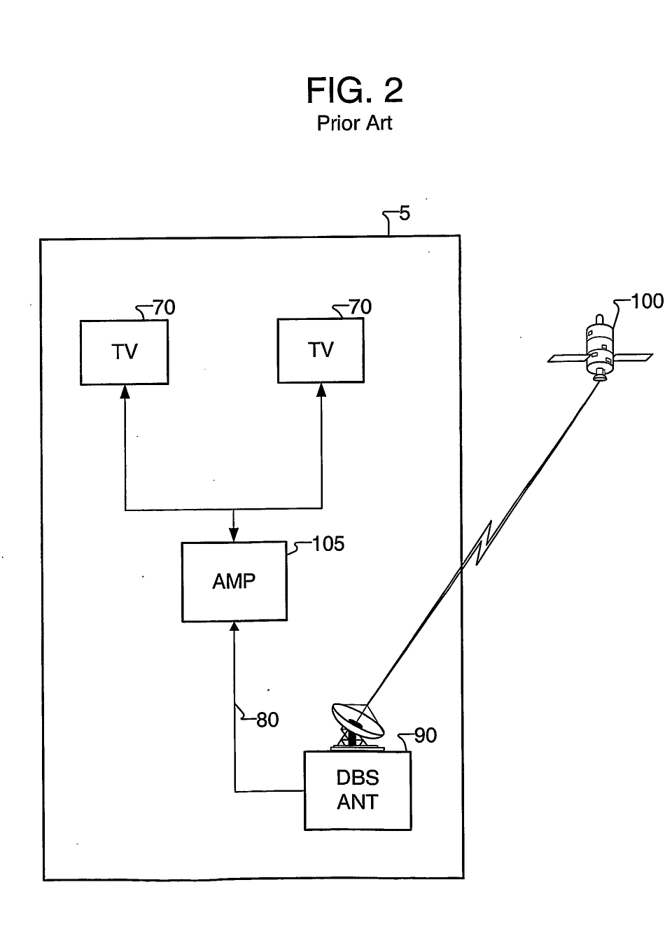

FIG. 3 shows, in highly simplified schematic form, an example of a system according to the invention for using a mobile radio inside a building by connecting to an indoor cellular antenna which is part of an enhanced DBS cable system.

FIG. 4 pictorially shows a relationship between different frequencies in a mobile radio system and a DBS cable system.

FIG. 5 depicts a cellular entrance module according to one aspect of the system shown in FIG. 3.

FIG. 6 shows an exemplary conversion module for handling GSM 1800 traffic as part of the cellular entrance module shown in FIG. 5.

FIG. 7 pictorially shows the relationship between shifted mobile radio frequencies and a DBS cable system.

FIG. 8 depicts a cellular transport module according to one aspect of the system shown in FIG. 3.

FIG. 9 depicts a network coupling device according to one aspect of the system shown in FIG. 3.

FIG. 10 shows a DBS mounted third generation module according to an aspect of the invention.

FIG. 11 shows, in highly simplified schematic form, a different example of a system according to the invention for using a mobile radio inside a building by connecting to an indoor cellular antenna which is part of an enhanced DBS cable system.

FIG. 12 pictorially shows a relationship between different frequencies in a plurality of mobile radio systems and a DBS cable system.

FIG. 13 shows an example of a cellular entrance module for interfacing with a plurality of mobile radio systems, according to an aspect of the invention.

FIG. 14 shows an exemplary conversion module for handling UMTS traffic.

FIG. 15 shows an example of a cellular entrance module for interfacing with a plurality of mobile radio systems, and also a plurality of mobile radio providers, according to an aspect of the invention.

FIG. 16 pictorially shows a relationship between different frequencies in a system according to the invention in which a plurality of mobile radio systems and a plurality of mobile radio providers are involved.

FIG. 17 shows a DBS mounted third generation module according to an aspect of the invention, in which a plurality of mobile radio systems are involved.

FIG. 18 shows a detailed example of a part of a DBS mounted third generation module according to an aspect of the invention, in which a plurality of mobile radio systems are involved.

### DETAILED DESCRIPTION

The invention will now be taught using various exemplary embodiments. Although the embodiments are described in detail, it will be appreciated that the invention is not limited to just these embodiments, but has a scope that is significantly broader. The appended claims should be consulted to determine the true scope of the invention.

Embodiment 1.

A conventional DBS network running from the rooftop antenna to the customer premises is typically a one-way network having a tree and branch topology with cables, amplifiers, signal splitters/combiners and filters. According to one aspect of the inventive system, the cables and other passive components like signal splitters/combiners are not modified, but the other active elements and filters are. Thus, the system includes new components for a DBS system that permits to overlay a multi-band, multi-standard, bi-directional communication system. The modified components allow both types of signals (the DBS signals and the cellular up and down signals) to be carried by the network simultaneously in a totally independent manner (avoiding cross-coupling, which can be a source of an unacceptable interference).

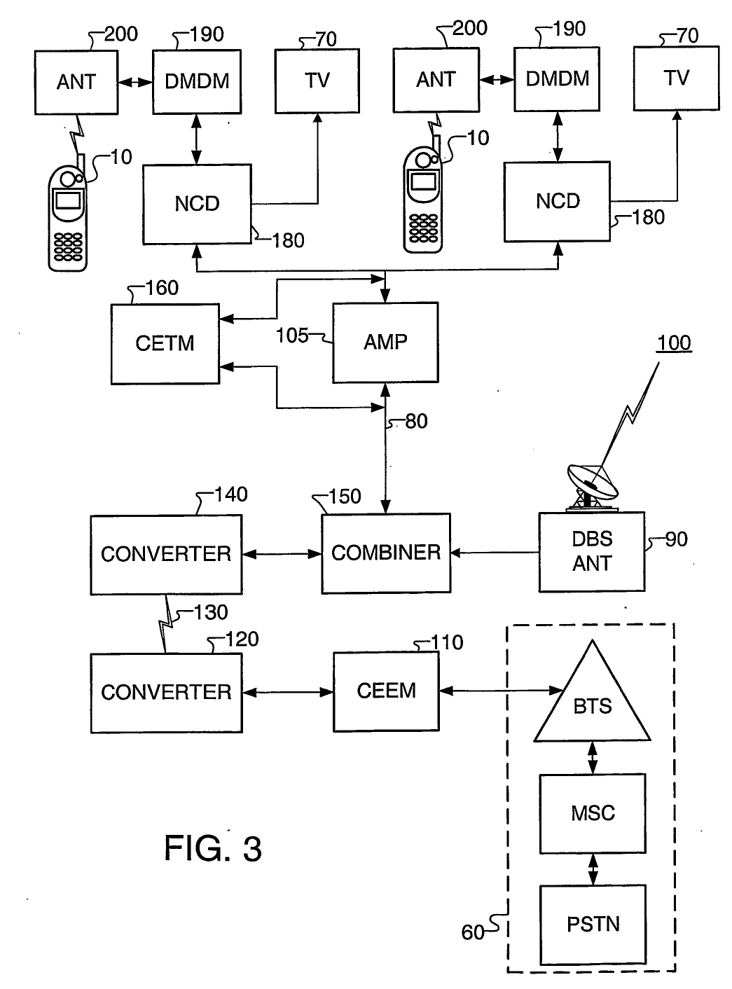

FIG. 3 shows an exemplary system according to this embodiment of the invention.

In FIG. 3, DBS programming is received from satellite 100 through the DBS antenna 90 and the DBS cable system 80. The DBS programming eventually reaches the televisions 70.

Of interest is the augmentation of the DBS system so that mobile radio traffic can be carried through the DBS cable system 80, thereby making it an upgraded DBS system. The upgraded DBS network that can support the delivery of 2G (GSM, TDMA, CDMA One, PDC) and 3G (UMTS, CDMA2000) cellular signals.

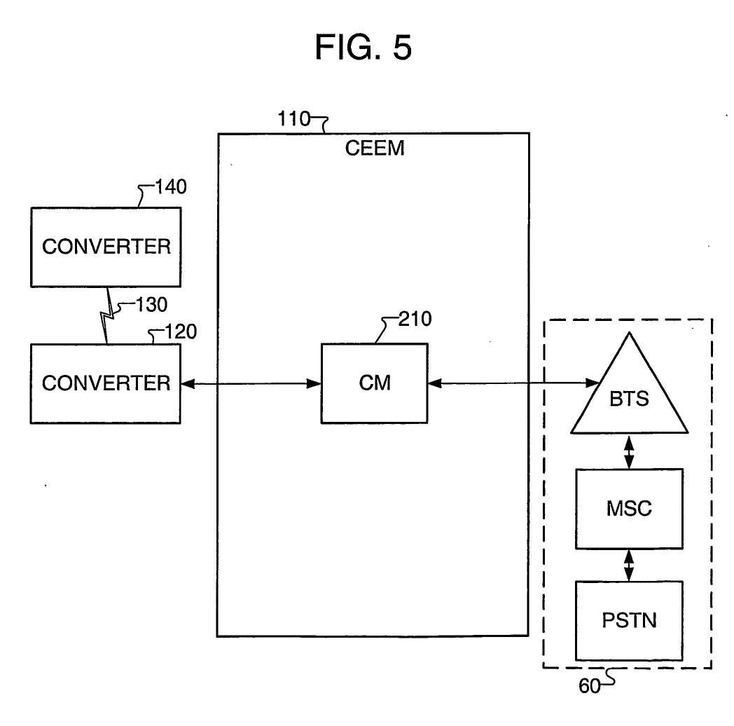

The BTS of the mobile radio system 60 interfaces with a CEllular Entrance Module (CEEM) 110, which is shown in more detail in FIG. 5, below. The purpose of the CEEM is to convert the frequency of the cellular telephone signals.

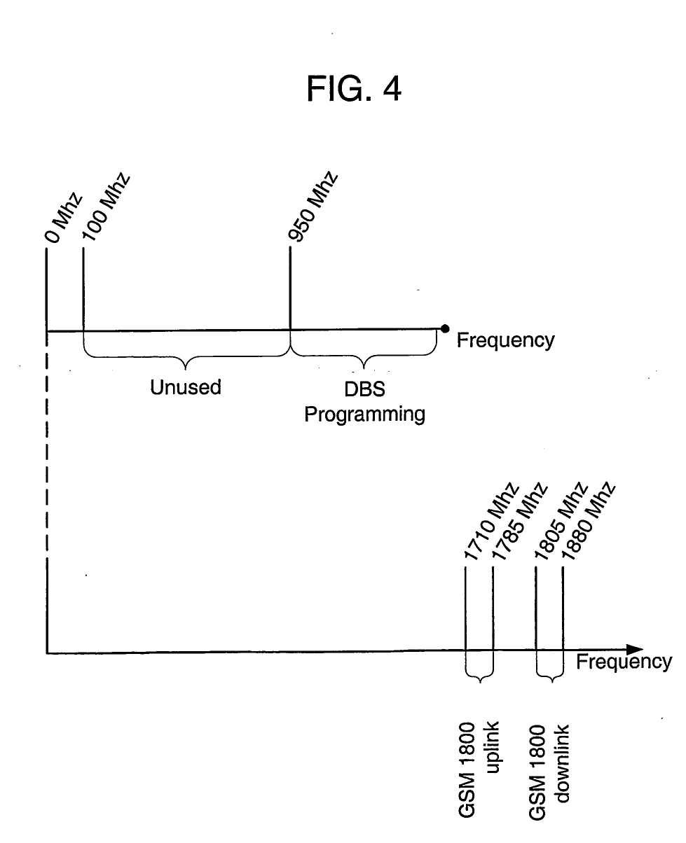

The need to convert the frequency of the cellular telephone signals will be explained by way of an example in connection with FIG. 4. In FIG. 4, the frequency spectrum use for the DBS cable system is shown above, and the frequency spectrum use for a mobile radio system (GSM in this example) is shown below. As can be seen in FIG. 4, the DBS programming is carried at frequencies at 950 MHz and above. The DBS cable system does not carry signals at the frequencies used by the mobile radio system, and therefore may be thought of as an incompatible cable system.

Turning now to FIG. 5, there is shown the CEEM 110. The CEEM 110 interfaces with the mobile radio system 60 and communicates with the converter 120 (i.e., a signal translator). In this example, the CEEM includes only one conversion module 210. The conversion module being considered in this example is a conversion module for the GSM system. Different conversion modules and multiple conversion modules are possible, as will be later described further below.

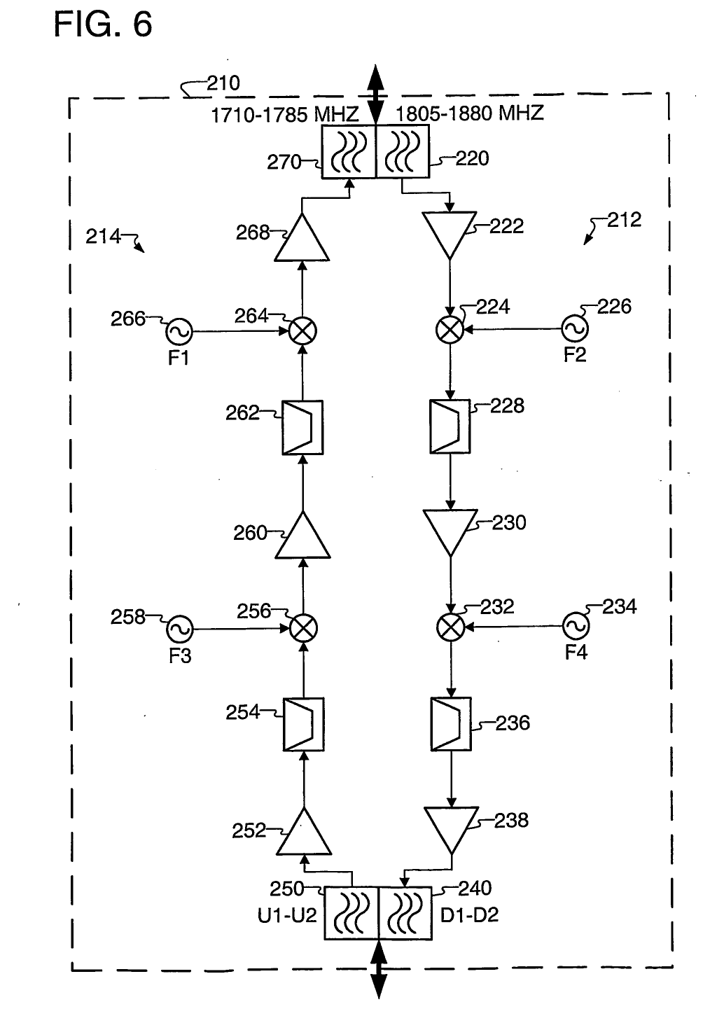

FIG. 6 shows one example of how to implement a conversion module 210 of a CEEM 110. In this example, the mobile radio system signals are those according to the GSM 1800 standard. The downlink side of the CEEM 110 is indicated by reference numeral 212, and the uplink side by reference numeral 214.

Downlink signals (i.e., those between 1805 and 1880 MHz) are received through the filter 220 and amplified by amplifier 222. The downlink signals are frequency translated so as to occupy a predetermined part of the spectrum within the 100-950 MHz part of the DBS cable system that is unused. For example, the downlink signals can be frequency translated to the band 550-625 MHz or any other desirable band. In FIG. 6, this frequency band is indicated by D1-D2. The frequency translation is accomplished using oscillators 226 and 234, and also mixers 224 and 232. The cellular signals 236 at that point are amplified again at amplifier 238 and go through the filter 240.

Uplink signals are received through filter 250. These signals may be in the translated frequency band, for example, 350-425 MHz. Of course, any other desired band may be used within the unused part of the DBS cable system. In FIG. 6, the selected frequency band is indicated by U1-U2. The signals are amplified by amplifier 252 and the thus-amplified and filtered signals 254 are frequency translated using oscillators 258 and 266, as well as mixers 256 and 264. The cellular signals at this point (in the frequency range 1710-1785 MHz) are amplified by amplifier 268 and go out through filter 270 to the BTS of the mobile radio network 60.

As will be appreciated, the frequency conversion is carried out by mixing the signals with accurate local oscillation (LO) sources 266, 226, 258, and 234, respectively at frequencies F1, F2, F3, and F4. The figure shows a double conversion scheme which offers more flexibility in choosing the LO specific frequencies and the band pass filters (220, 240, 250, 270). In some cases, a single conversion scheme may be sufficient. The frequency signals 228 on the downlink side and 262 on the uplink side may thus be understood to be intermediate frequency signals having a frequency based on the particular frequencies F1-F4 used in the oscillation sources. The amplifiers 230 and 260 amplify the intermediate frequency signals.

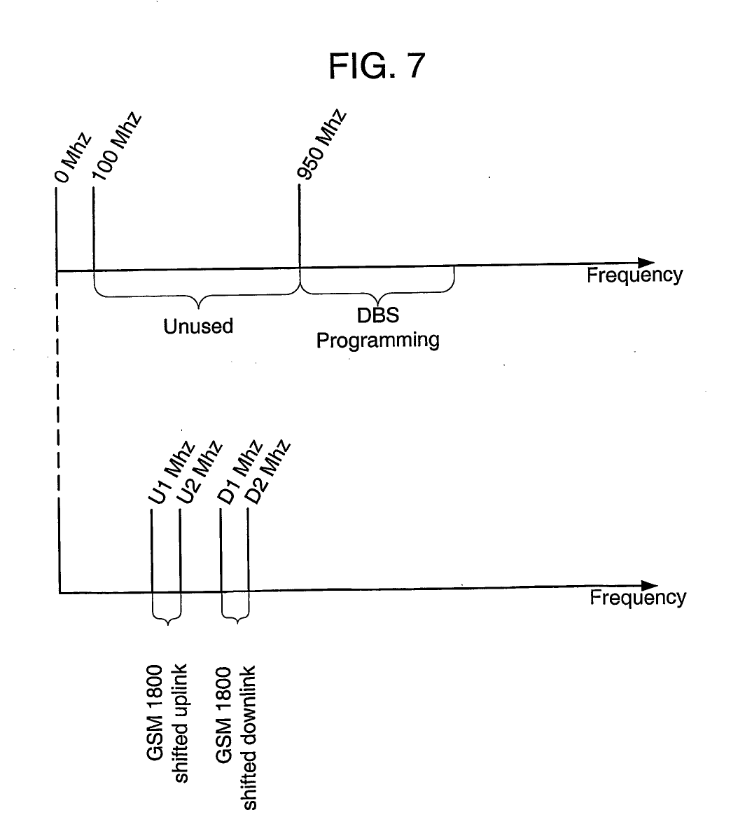

After frequency conversion, the signals may be thought of as shifted uplink and shifted downlink signals (or, together, as shifted mobile radio signals), and are now in the unused portion of the DBS cable system as illustrated in FIG. 7.

Returning to FIG. 3, the CEEM 110 then communicates the shifted cellular signals with the converter 120. Converter 120 and converter 140 communicate with each other via any suitable communication means 130 such as fiber, coax, wireless, laser beam, or the like. If fiber is used, for example, the converter 120 and the converter 140 are responsible for converting the frequency shifted signals into a form that can be carried over the fiber and converting them back again afterwards. The converters 120 and 140 may thus be thought of as signal translators for taking RF signals and putting them in a form suitable for communication to the building 5, and for translating them back to RF signals.

The converter 140 communicates the shifted cellular signals with the combiner 150. The combiner 150 combines the shifted cellular signals and the DBS programming signals to provide a combined signal to be carried through the coaxial distribution network that constitutes the DBS cable system 80.

As already mentioned, the DBS cable system 80 includes various active components, such as amplifier 105. At any such active component, it is necessary to install a CEllular Transport Module (CETM) 160.

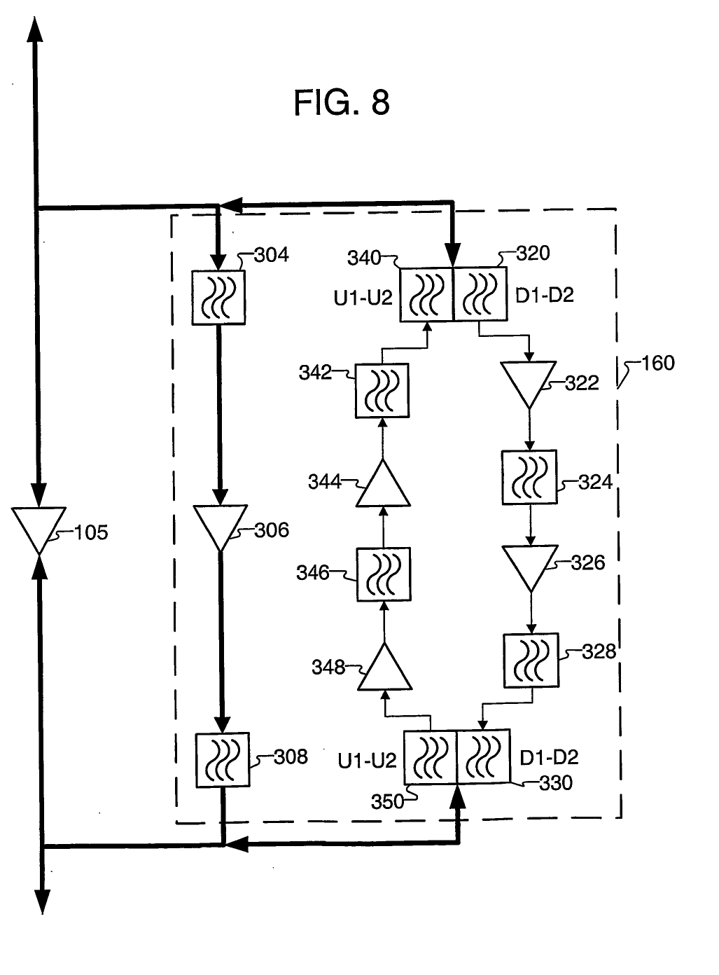

FIG. 8 shows a CETM 160 and an amplifier 105. The amplifier 105 amplifies the DBS programming.

Before and after the amplifier a connection is made, and a path is provided around the amplifier 105 and through the CETM 160.

Into the CETM 160, downlink signals pass through filter 320, and are amplified and filtered as indicated at 322, 324, 326, and 328. The downlink signals pass through the filter 330 and then rejoin the DBS cable system 80. Likewise, uplink signals pass through filter 350, and are amplified and handled as indicated at 348, 346, 344, and 342. The uplink signals go through filter 340 and rejoin the DBS cable system 80.

The CETM 160 for the present GSM 1800 example is a bi-directional amplifier repeater that amplifies the up-link and downlink cellular signals. It also may include amplification for injected LO signals (described below) by means of filters 304 and 308, and amplifier 306.

The CETM acts on both up and down link signals to amplify and filter the cellular frequency converted signals. The amplifiers compensate the loss of the DBS cabling network. The filters and duplexers prevent oscillations between the up and the down link signals.

It will be appreciated that the CETM could be installed even when an active component like a DBS amplifier is not present. That is, the CETM may be employed in situations in which only the cellular signals need to be amplified.

Returning to FIG. 3, it can be seen that the combined signal eventually gets to each television location. At the user premises, at a DBS cable system outlet, there is a network coupling device (NCD) 180, a DBS Mounted thirD generation Module (DMDM) 190, and an indoor cellular antenna 200.

The NCD, DMDM, and antenna may be combined into the user's set top box, or may be in a separate unit, or may each be realized as separate components. Either way, it will be appreciated that the NCD, DMDM, and antenna together may be thought of as an end user equipment set. The DMDM itself, for simplicity, may be referred to as an end user frequency conversion module.

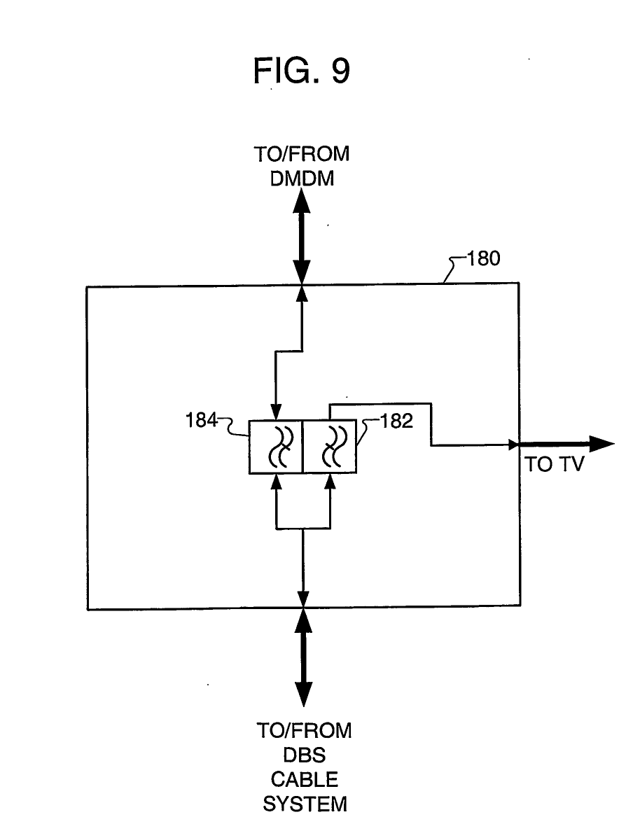

FIG. 9 shows the NCD 180. As shown in this example, the NCD 180 has three ports. One port connects to the DBS cable system 80. Another port goes to the television 70. The third port goes to the DMDM 190. Although the NCD 180 can be implemented in a variety of ways, one approach is to use a high pass filter 182 to divert the DBS programming signals to the TV, and to use a low pass filter 184 to divert the mobile radio signals to the DMDM.

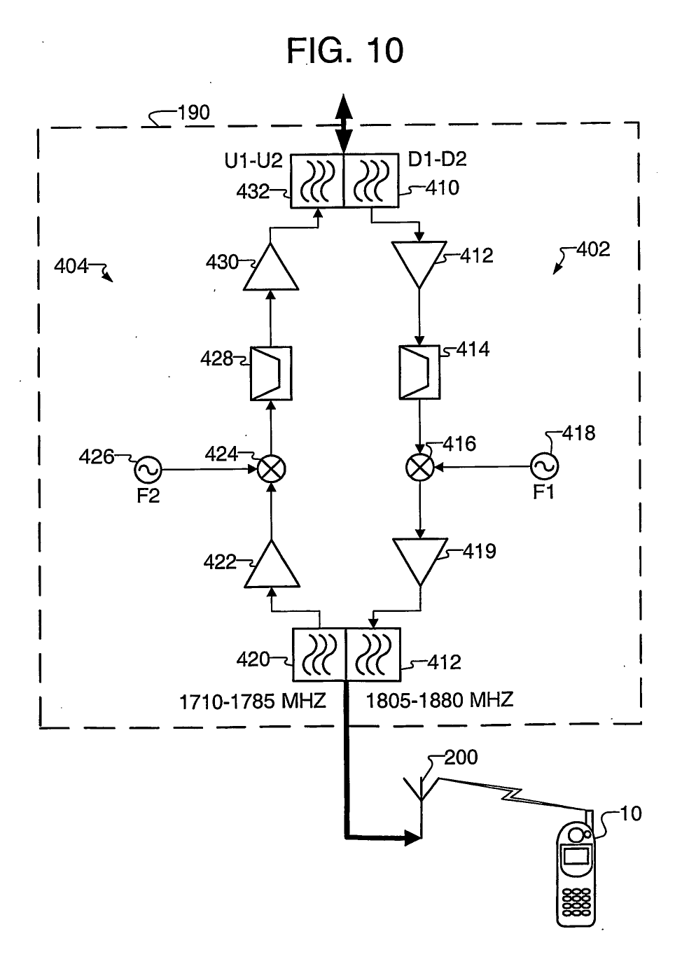

FIG. 10 shows the DMDM 190, in one exemplary embodiment. The signals from the NCD are communicated via filters 410 and 432. The DMDM shown here exemplifies the approach of converting using only one oscillator. The single oscillator is appropriate when, as in this example, one mobile radio system 60 is being supported over the DBS cable system 80. An example of a DMDM suitable for more than one system is shown further below.

The downlink side of the DMDM is indicated by reference numeral 402, and the uplink side is indicated by reference numeral 404.

The downlink signals pass through filter 410 and are amplified and filtered with amplifier 412 and band pass filter 414. The amplified and filtered signals are mixed 416 with a frequency F1 from local oscillator source 418. The result, a downlink signal that has been shifted back to the original frequency, is amplified by amplifier 419 and passed through filter 412.

The downlink cellular signal, restored to its original frequency, is communicated via indoor antenna 200 to the mobile station 10.

As to uplink signals, the cellular signals at their original frequency are received that indoor antenna 200 from mobile station 10. The uplink signals pass through filter 420 and are amplified and shifted with amplifiers 422 and 430, local oscillator 426 at frequency F2, and mixer 424. The shifted cellular signals pass through filter 432 to the NCD 180. It will be appreciated that, although the filters 412 and 420 indicate the frequencies particular to the GSM 1800 system, the exemplary DMDM 190 shown in FIG. 10 could be used with appropriate modifications in connection with any other mobile radio system. It will also be appreciated that, although the mobile station 10 is indicated as being a cellular phone, any mobile station such as a PDA or the like would be appropriate to use with the system.

Embodiment 2.

The local oscillator frequencies shown in FIG. 10 may be provided by including precise local oscillators in the DMDM 190. Such sources of local oscillator frequencies can prove expensive, however, in view of the large number of DMDM units in the building 5.

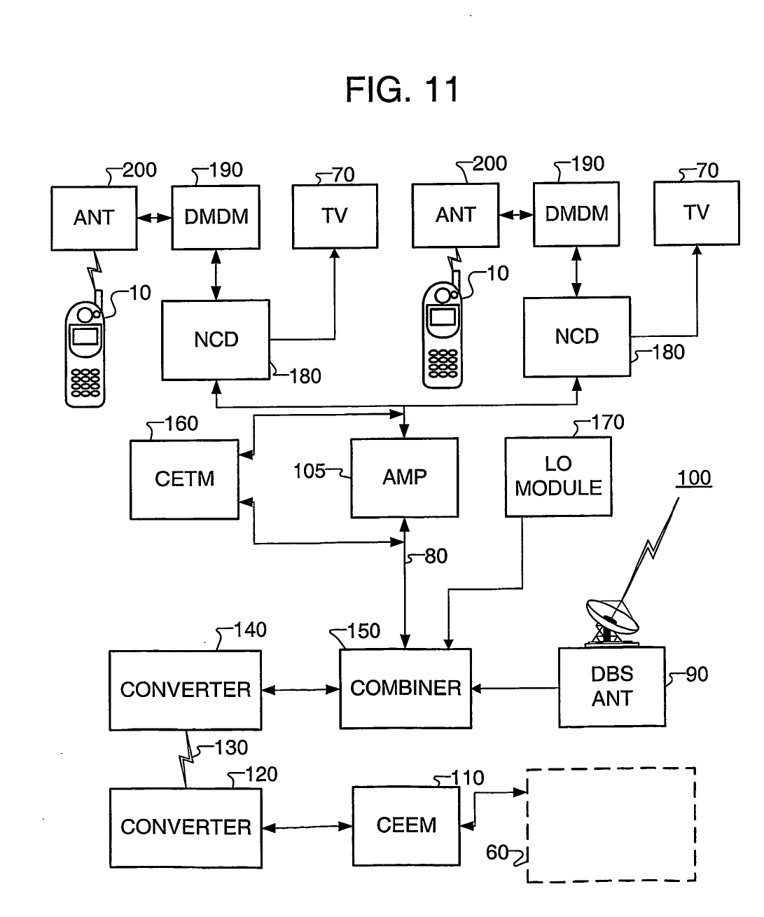

In the present embodiment, therefore, as shown in FIG. 11, a local oscillator module 170 is provided so as to inject as a pilot continuous wave (CW) signal, the desired local oscillator frequencies into the system at the combiner 150. This may be referred to as an injected LO signal, and it may be said that, since the LO signal is injected at the building 5, the LO signal is being injected into the access section of the DBS network. The LO signal is carried along the DBS cable system 80 to each DMDM 190 in the building 5. The DMDM uses this LO signal to convert back the cellular up and down link signals back to their original standard frequencies.

This method of transporting the local oscillator frequencies along the network to the DMDM eliminates the need for using precise and expensive frequency sources in the DMDM. This can reduce the complexity and cost of the DMDM for the subscriber. Of course, this method of transporting the LO frequencies is economical but not required, and precise local oscillators may be provided in the DMDM if preferred.

A variation on this embodiment is to inject the LO signal at the CEEM 110.

Embodiment 3.

According to this embodiment of the invention, the injected LO signal may be used as a power source for the DMDM. The injected LO signal (injected by the module 170 shown in FIG. 11) includes one or more oscillation frequencies generated so as to carry enough RF energy so that the signals can (e.g., at the DMDM) be rectified and converted into a Direct Current (DC), thereby providing the necessary supply of power for the operation of the DMDM. In this embodiment, the need for an external source of DC power in the vicinity of the DMDM is eliminated.

Embodiment 4.

According to this embodiment of the invention, the DMDM is powered by RF energy from a frequency below the lowest DBS frequency in use. That is, a low frequency signal is generated below the DBS frequencies, is injected by module 170, is rectified at the DMDM 190, and supplies the DC power for the DMDM.

Embodiment 5.

According to this embodiment, more than one type of cellular signal is carried over the DBS cable system 80. This may be referred to as a multi-band system.

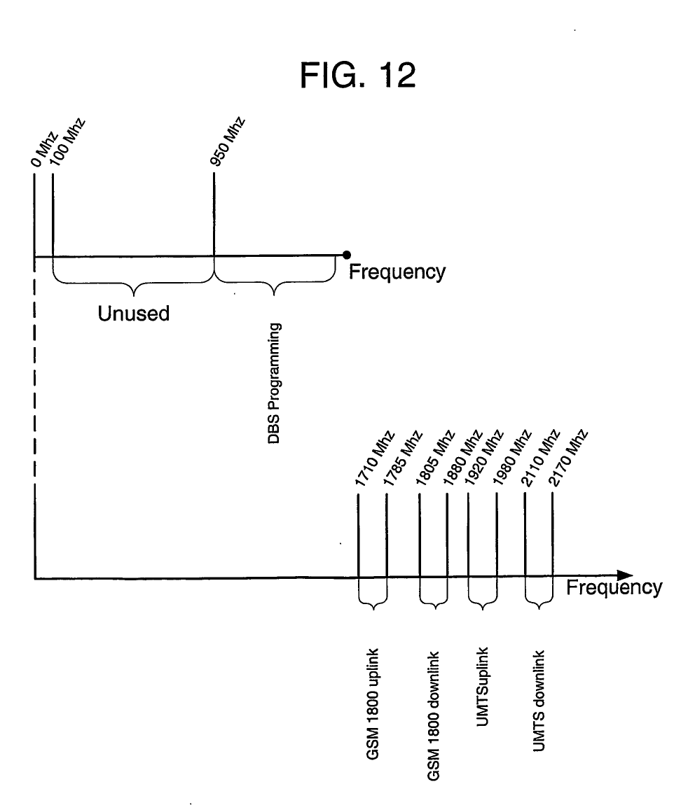

Although FIG. 12 shows two different bands (i.e., the GSM 1800 bands, and the UMTS bands), it will be appreciated that the teaching relating to this embodiment relates to any mobile radio systems or combinations of systems. This includes, but certainly is not limited to UMTS, GSM900, GSM1800, PCS1900, TDMA800, CDMA800 or PDC, even simultaneously, without degrading the DBS services or the cellular services.

As can be seen in FIG. 12, the mobile radio frequencies are all outside the frequency spectrum which can be carried by the cable. Each band must therefore be converted to a frequency that can be carried by the DBS cable system 80, and also which does not interfere with the DBS programming. The system as shown in FIG. 3 or FIG. 11, for example, may be used with some few changes.

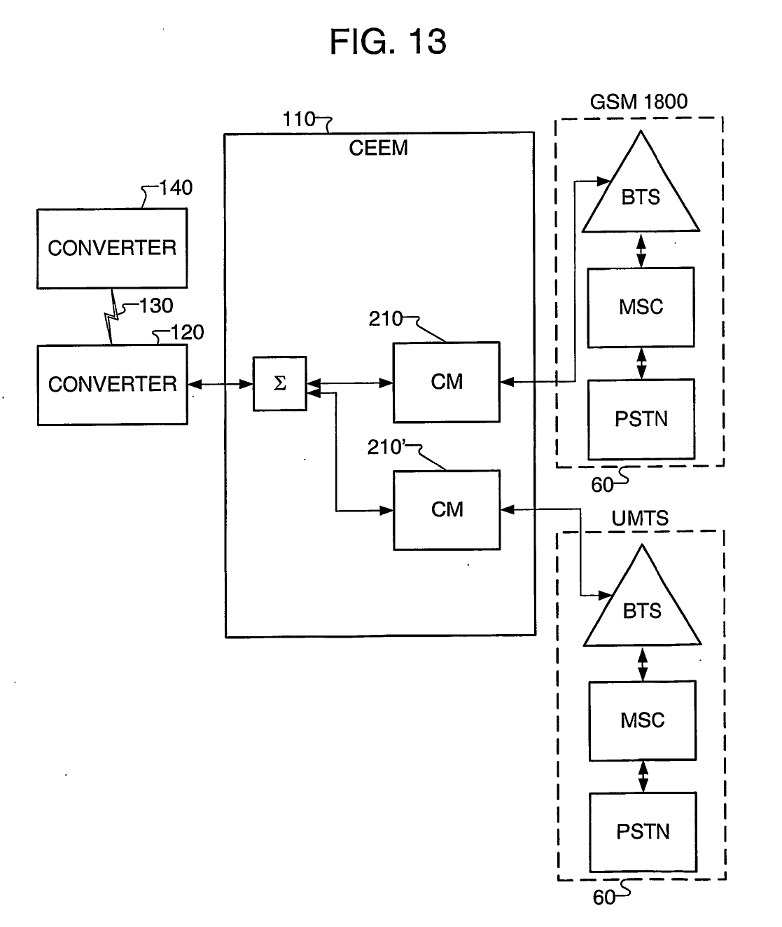

One of the changes is shown in FIG. 13. FIG. 13 is substantially similar to FIG. 5, except that this exemplary embodiment of the CEEM 110 handles traffic for a plurality of mobile radio systems. In particular, the CEEM 110 handles traffic from a GSM 1800 system and also a UMTS system.

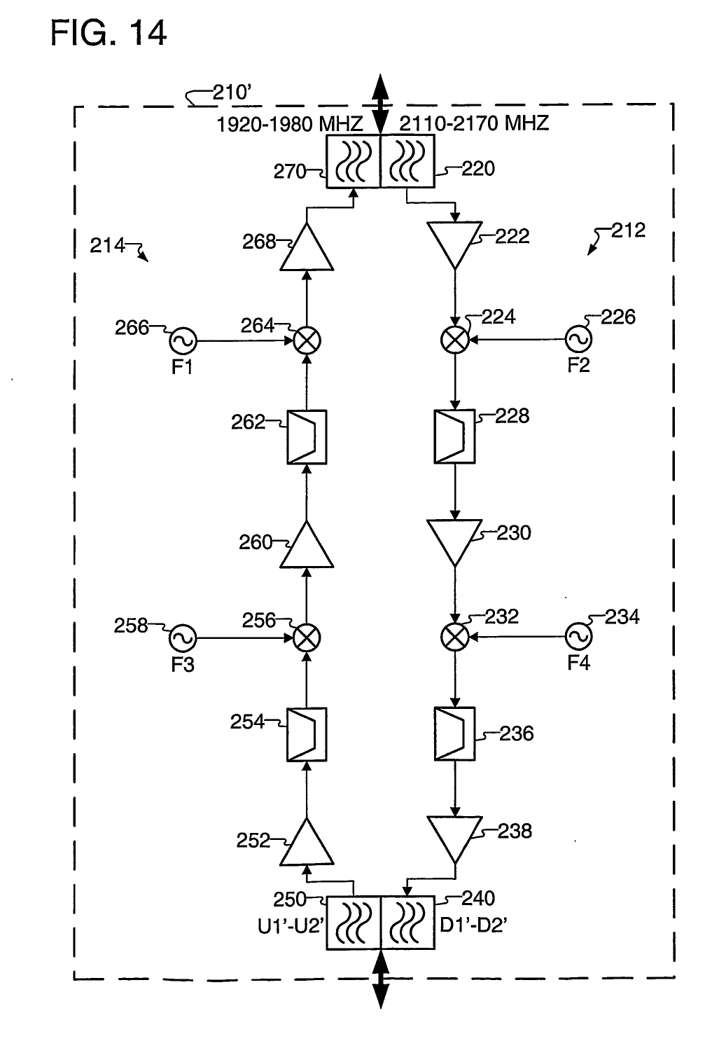

The traffic from the GSM 1800 system is handled by the configuration module 210 as already described above. The traffic from the UMTS system is handled by the configuration model 210′ as shown in FIG. 14.

FIG. 14 is substantially the same as FIG. 6, except that the frequencies of the mobile radio signals being shifted are different (i.e., the UMTS uplink and downlink frequencies are different from the GSM 1800 uplink and downlink frequencies), and the frequencies to which the mobile radio signals are shifted are also different (i.e., the GSM 1800 uplink and downlink frequencies were shifted to one part of the unused spectrum in the DBS cable system 80, and the UMTS uplink and downlink frequencies need to be shifted to a different part of the unused spectrum in the DBS cable system 80).

Embodiment 6.

According to this embodiment, there is not only a plurality of mobile radio systems (i.e., a multi-band system), but there is also a plurality of mobile radio providers.

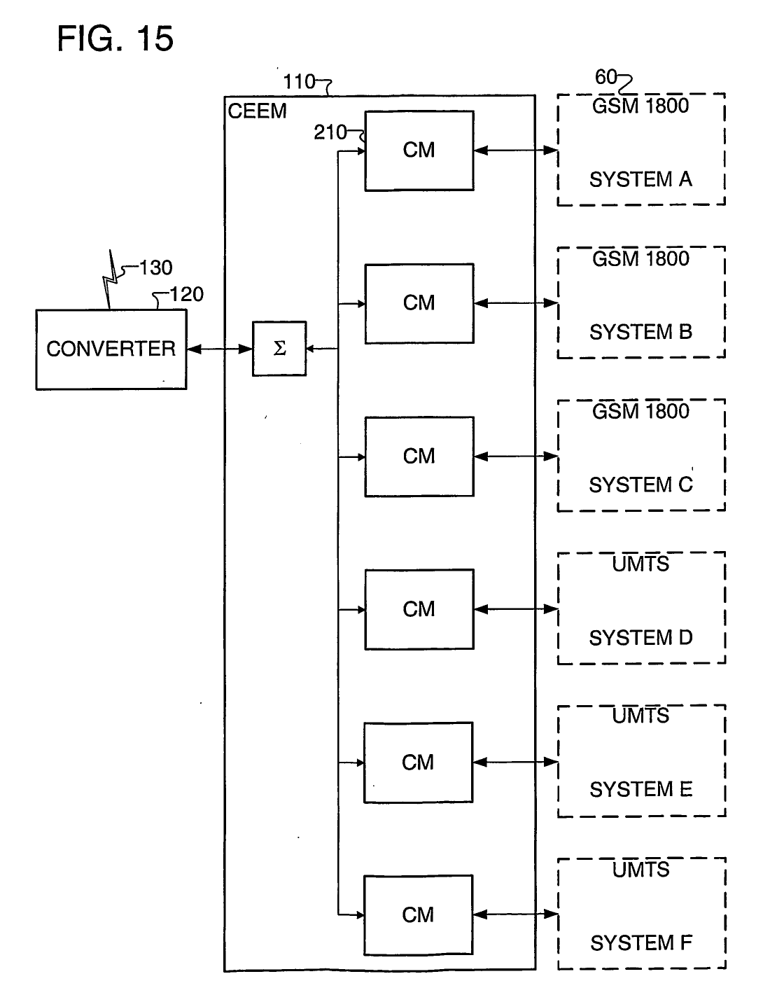

FIG. 15 shows how this is handled at the cellular entrance module 110. In particular, for each different mobile radio system/provider 60, a separate configuration module 210 is provided.

In this example, some UMTS and GSM1800 sub-bands are frequency translated, combined and carried over a single DBS network.

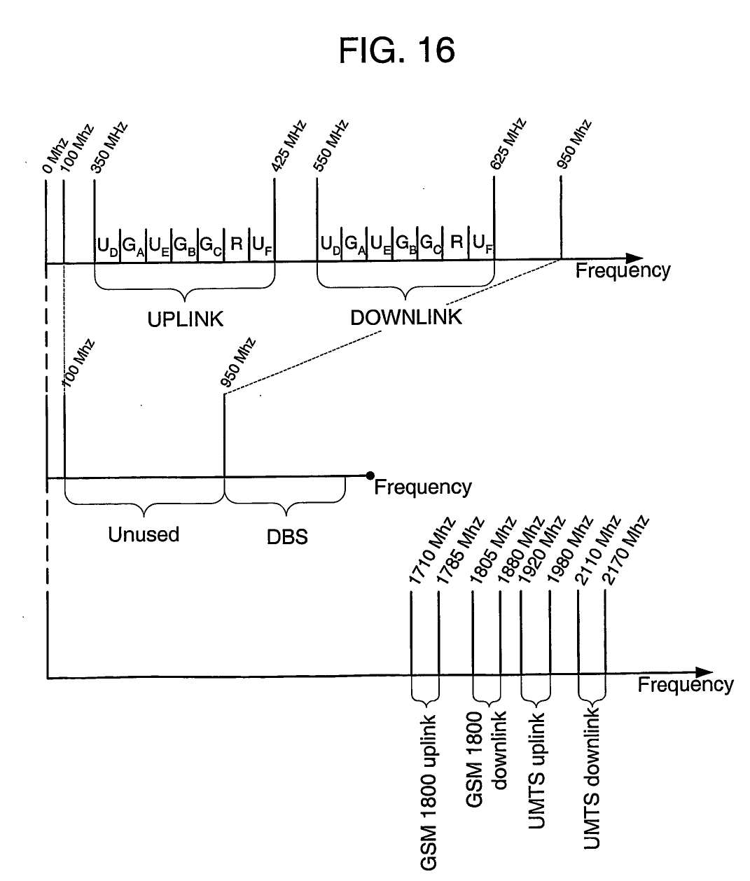

FIG. 16 shows the UMTS and GSM1800 before and after the frequency conversion. That is to say, the GSM 1800 system indicated as system A in FIG. 15 is frequency translated so that the uplink traffic for system A occupies the part of the shifted uplink signals (UPLINK in the upper part of the figure) indicated by G_{A} (“G” for GSM 1800 and “A” for system A). The GSM 1800 system indicated as system A in FIG. 15 is also frequency translated so that the downlink traffic from system A occupies the part of the shifted downlink signals (DOWNLINK in the upper part of the figure) as indicated also by G_{A}.

Likewise, the example shown in FIG. 16 indicates how each of the mobile radio signals communicated with systems/providers B-F are frequency translated into the shifted uplink signals and the shifted downlink signals that are carried over the DBS cable system 80. The symbol “R” indicates a reserved band, which may be used for any particular purpose.

The sub-bands may each carry the traffic for a different service provider. In this example, 3 sub-bands of GSM1800 are frequency translated from their original band (1710-1785 Mhz & 1805-1880 Mhz) to anywhere within the new DBS band (350-425 Mhz & 550-625 Mhz).

In addition, 3 sub-bands (each may be one 5 Mhz UMTS carrier) of UMTS are also translated to within the same band. The reserved frequency block in the figure, designated by R, may be used to add another sub-band of an existing or a new service provider. Each up-link or downlink sub-band is translated independently by using a different local oscillator (as shown by the examples above). Guard bands between the sub-band are not shown in the figure for the sake of simplicity. However, if guard bands are needed between the sub-bands, the local oscillator frequencies can be set so as to create them.

The sub-bands are created out of the original standard frequency allocation of mobile radio systems. The bandwidth of the sub-band to be translated is not limited by the proposed system. The mobile radio system provider may be offered to transport up to all the bandwidth he owns by this system. The maximal system capacity in the example is 2×75 MHz, and it may serve as many service providers as desired until that capacity is exhausted.

It will be appreciated that the use of particular mobile radio systems in this example, and the shifting of their signals to particular parts of the 100-950 MHz spectrum is for the sake of example only, and that virtually any combination of mobile radio systems from any set of mobile radio system providers can be handled in like manner. It will also be appreciated that the mobile radio signals can be shifted to any part of the unused spectrum of the DBS cable system.

It will also be appreciated that the unused part of the spectrum in the exemplary DBS cable systems described above is 100-950 MHz, but this may vary and may even change somewhat in the future, and that the teaching herein is equally applicable to unused parts that are not strictly limited to 100-950 MHz.

Embodiment 7.

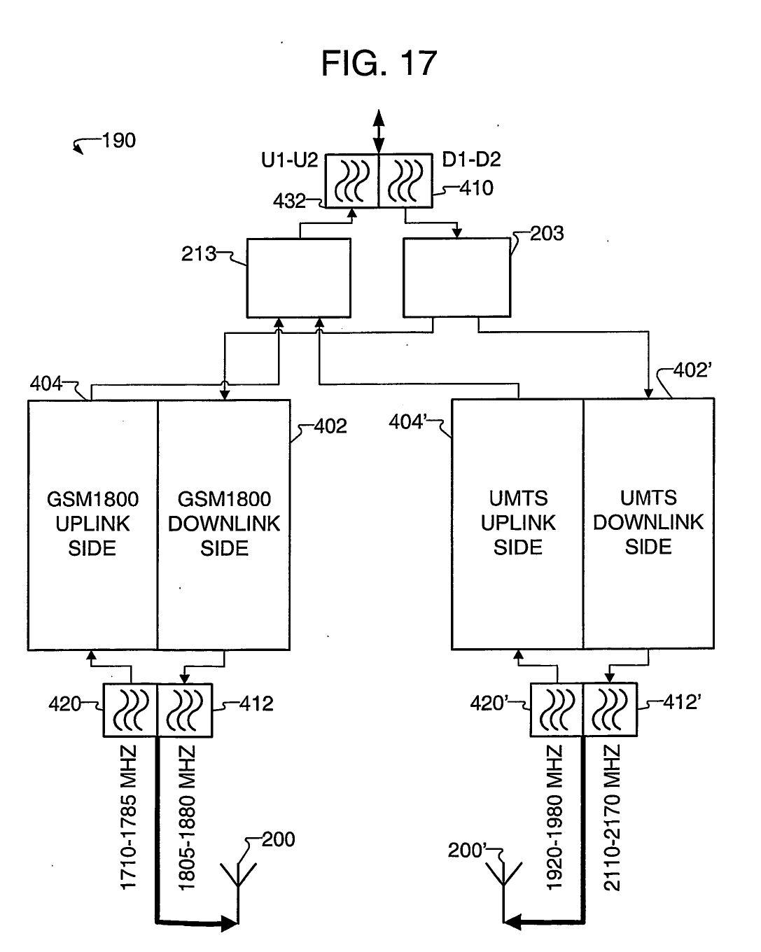

In this embodiment, the DMDM handles more than one radio system. That is to say, the frequency conversion apparatus at the user end has a multi-band module.

Whereas FIG. 10 showed a DMDM suitable for single band operation, FIG. 17 shows an example of an apparatus that will serve as a DMDM 190 when two different mobile radio systems are involved.

In this figure, in particular, the DMDM has a dual band GSM1800/UMTS module. Other types of modules can be imagined, such as modules for: GSM900/GSM1800, UMTS/GSM900, PCS1900/TDMA800, PCS1900/CDMA800, PDC/UMTS). Even triple band modules may be created along these lines to provide, for example, GSM900/GSM1800/UMTS type of service.

In more detailed description the combined signals enter at the DBS outlet. The signals are differentiated at the NCD 180 (see FIGS. 9 and 11). The DBS signals are routed to the Set Top Box and the down link cellular signals (410) which in the present example are in the range of 550-625 MHz are routed through the duplexer 410 to the divider 203 sending the corresponding signals to the UMTS down converter 402′ and to the GSM 1800 down converter 402. The down conversion is handled in any manner, but reference may be made to FIG. 10 and its accompanying discussion, above, for an operative example.

The original cellular frequency is filtered and passed through the duplexer (412, 412′). The filtering and the duplexer (both sides) provide good isolation between the up link and down link to prevent oscillations. The duplexer is connected to the antenna (200 or 200′) that transmits the signal.

At the up link the cellular signals are received at the antennas 200 and 200′ and routed to the duplexers (420, 420′). At the output of the duplexers, the uplink signals are down converted (to the desired lower frequency) by the UMTS UPLINK SIDE converter 404′ or the GSM 1800 UPLINK SIDE converter 404. The down conversion is likewise handled in any desired manner, but reference may be again made to FIG. 10 and its accompanying discussion for an operative example.

The signals, now in the range of, e.g., 350-425 MHz, are amplified and combined at combiner 213. They pass through 432 and then on to the NCD.

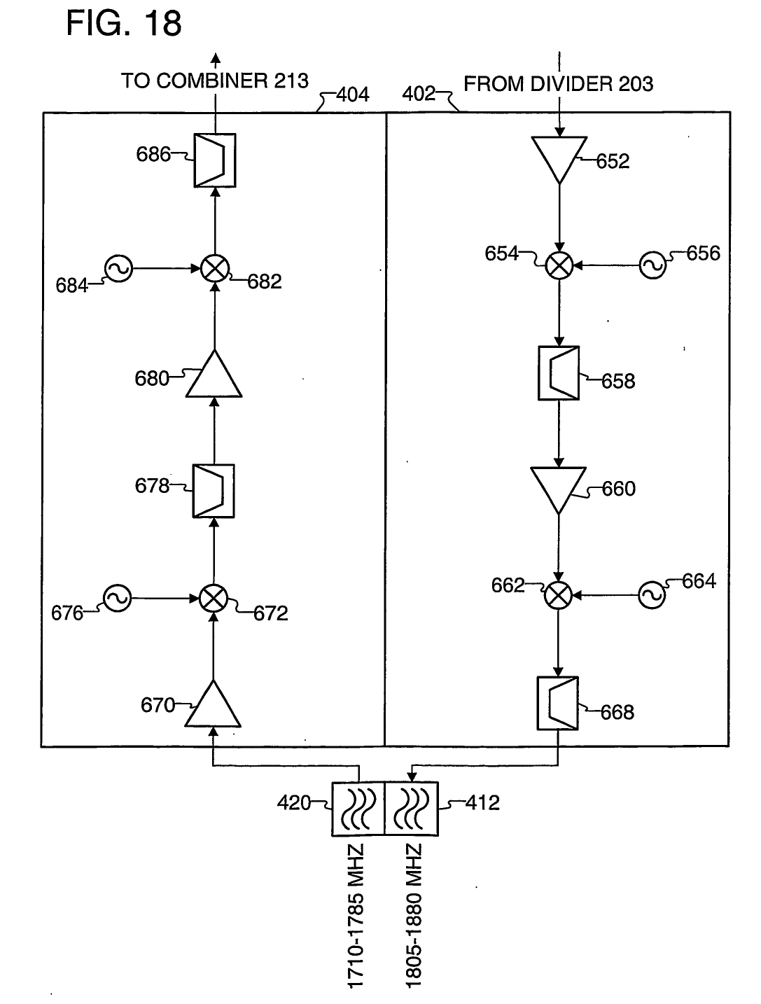

FIG. 18 shows the uplink 404 and downlink 402 sides for handling the GSM1800 signals. As was mentioned above, the single oscillator (i.e., single conversion) approach shown in FIG. 10 is appropriate for a situation in which one mobile radio system 60 is being supported over the DBS cable. In this example, however, more than one system is being supported and so a dual conversion is required both at the customer premises (at the DMDM 190) and at the head end (i.e., at the CEEM 110), since the signal of one system (such as the UMTS system) may interfere with the signals of the other (such as the GSM 1800 system) if they are not filtered via an intermediate frequency.

The downlink side converter 402 will first be discussed. Various other approaches will occur to those familiar with this field, but in the example shown in FIG. 18, the signals from the divider 203 are amplified 652 and down converted 654 to an intermediate frequency with a 10 MHz band width using source 656. The converted frequency is filtered with 10 MHz bandwidth 658, amplified 660, and than converted again 662 to the original cellular frequency using source 664. The original cellular frequency is filtered through 668 and duplexer 412. The filter and the duplexer (both sides) are responsible for good isolation between the up link and down link to prevent oscillations.

Now, the uplink side converter 404 will be discussed. At the output of the duplexer 420 the signals are amplified by the amplifier 670 and down converted 672 using source 676 to the intermediate frequency with a 10 MHz bandwidth. The filter 678 is responsible for the 10 MHz bandwidth. Then the signals are amplified again through 680 and up converted 682 to the desired frequency (somewhere in 350-425 MHz, in this example). After amplification 686, the signals pass on to combiner 213.

The structure shown in FIG. 18 can clearly be adapted for uplink side 404 and downlink side 402 converters for whatever mobile radio system is involved.

Conclusion.

The advantages of the invention are many. The capabilities of existing DBS networks are preserved, and mobile radio traffic capability is achieved, without modification to the mobile radio terminals. That is to say, the signals sent according to the radio communications protocol traverse the DBS network on non-utilized DBS frequencies (typically 100-950 MHz), but reaches the mobile terminals exactly at the same standard frequency as was originally produced by the base station.

Furthermore, the modifications to the DBS network can even be made with only linear components such as filters and amplifiers. Such modifications are simple to install, robust, and affordable.

One familiar with this field will understand that the use of the equipment and method described herein constitutes a method for enhancing the throughput of second and third generation cellular networks. With indoor cells accessed through the cellular cable network, the power of the transmitting mobile units indoors can be very low. This, coupled with the inherent attenuating effects that occur within buildings, combine to make it possible for a much better data service in indoor cells.

The various embodiments and aspects of the system described herein help overcome coverage and capacity constraints now faced by operators of cellular mobile radio networks. By mitigating these coverage constrains, the cost of providing excellent radio coverage is reduced and service levels are improved.

Although the invention has been described above using some concrete examples for the sake of explanation, it will be appreciated that these examples and the enclosed figures are not intended to limit the scope of the invention, which is to be determined based on the appended claims. Many minor modifications and changes will occur to those familiar with this field, and may be made without departing from the scope and spirit of the invention.

1. A method for providing indoor mobile radio service for an indoor mobile radio to communicate with a mobile radio network of a mobile radio system, the method comprising:
receiving direct broadcast satellite (DBS) programming signals through a DBS antenna connected to a DBS cable system of a building;
receiving RF mobile radio signals of the mobile radio system;
communicating both the DBS programming signals and the RF mobile radio signals over the DBS cable system;
communicating the RF mobile radio signals, via the DBS cable system, between the indoor mobile radio and the mobile radio network.

2. The method for providing indoor mobile radio service as set forth in claim 1, further comprising shifting the original frequency of the mobile radio signals to an unused part of the spectrum of the DBS cable system when the mobile radio signals are communicated over the DBS cable system.

3. The method for providing indoor mobile radio service as set forth in claim 1, wherein the indoor mobile radio communicates the mobile radio signals through an indoor antenna.

4. The method for providing indoor mobile radio service as set forth in claim 1, wherein the DBS cable system includes a cellular transport module, at each active component, for bypassing the mobile radio signals around the active component and for increasing the quality of the mobile radio signals.

5. The method for providing indoor mobile radio service as set forth in claim 1, further comprising a cellular entrance module communicating the mobile radio signals to and from the mobile radio network, and having a configuration module shifting the original frequency of the mobile radio signals to an unused part of the spectrum of the DBS cable system.

6. The method for providing indoor mobile radio service as set forth in claim 5, wherein the mobile radio signals, after the shifting of the frequency at the cellular entrance module, are translated and carried to the building.

7. The method for providing indoor mobile radio service as set forth in claim 6, wherein the cellular entrance module communicates with more than one mobile radio system and includes a configuration module for each of the mobile radio systems.

8. The method for providing indoor mobile radio service as set forth in claim 1, further comprising an end user equipment set for shifting the original frequency of the mobile radio signals to an unused part of the spectrum of the DBS cable system.

9. The method for providing indoor mobile radio service as set forth in claim 1, wherein the end user equipment set includes:
an indoor cellular antenna for communicating the mobile radio signals at the original frequency,
an end user frequency conversion module for performing the frequency shifting to provide shifted mobile radio signals, and
a network coupling device for communicating the shifted mobile radio signals between the end user frequency conversion module and the DBS cable system.

10. The method for providing indoor mobile radio service as set forth in claim 9, wherein the end user frequency conversion module is a dual band module for performing the frequency shifting for more than one mobile radio system.

11. A method of communicating cellular traffic over a direct broadcast satellite (DBS) network, comprising:
providing a cellular entrance module (CEEM) in communication with a base transceiver station (BTS) of a cellular network;
providing a DBS mounted third generation module (DMDM) at a termination point of said DBS network; and
providing a cellular transport module (CETM) at every active component of said DBS network;
receiving, at said CEEM, unmodified wireless RF down-link signals, and, at said DMDM, unmodified wireless RF up-link signals; and
shifting the frequency of the unmodified wireless RF signals, at the CEEM and the DMDM, for communication over the DBS network at frequencies below the DBS programming signals of the DBS network.

12. The method of communicating cellular traffic over a DBS network as set forth in claim 11, further comprising signal translating the frequency shifted RF signals to another format for communication between the CEEM and a building having the DBS network.

13. The method of communicating cellular traffic over a DBS network as set forth in claim 12, wherein the format, for communication between the CEEM and the building having the DBS network, is a format compatible with communications means selected from the set consisting of: fiber, coax, laser beam, and wireless communications.

14. A method of communicating mobile radio traffic over part of a direct broadcast satellite (DBS) network, comprising:
providing a cellular entrance module (CEEM) in communication with a base transceiver station (BTS) of a mobile radio network;
providing an end user frequency conversion module (DMDM) at an indoor termination point of the DBS network;
providing a cellular transport module (CETM) at an active component of the DBS network so as to provide a signal path around the active component;
receiving original cellular signals, including:
at said CEEM, original cellular down-link signals, and
at said DMDM, original cellular up-link signals;
shifting said original cellular signals to a frequency band lower than the DBS programming signals of said DBS network to provide shifted cellular signals, including:
at said CEEM, shifted cellular down-link signals, and
at said DMDM, shifted cellular up-link signals; and
communicating said shifted cellular signals along a signal path, between said CEEM and said DMDM, using an access section of the DBS, and via said CETM.

15. The method of communicating mobile radio traffic according to claim 14, wherein said original cellular signals are received in a frequency and format meeting a mobile radio standard.

16. The method of communicating mobile radio traffic according to claim 15, wherein the mobile radio standard is selected from the set consisting of UMTS, GSM900, GSM1800, PCS1900, TDMA800, CDMA800, and PDC standards.

17. The method of communicating cellular traffic according to claim 15, wherein said frequency band lower than said DBS programming signals of said DBS network is a band of 100-950 Mhz.

18. The method of communicating cellular traffic as set forth in claim 14, further comprising:
injecting, into the signal path, one or more pilot continuous wave (CW) frequencies as a local oscillator signal; and
performing reverse frequency translation using said local oscillator signal, at said DMDM, to perform said shifting of said mobile radio signals.

19. The method of communicating cellular traffic as set forth in claim 18, wherein the local oscillator signal is injected into the signal path at the CEEM.

20. The method of communicating cellular traffic as set forth in claim 18, wherein the local oscillator signal is injected into the signal path in the access section of the DBS cable system.

21. The method of communicating cellular traffic as set forth in claim 18, wherein the local oscillator signal includes only one pilot CW frequency.

22. The method of communicating cellular traffic as a set forth in claim 18, wherein the local oscillator signal includes two pilot CW frequencies.

23. The method of communicating cellular traffic as set forth in claim 18, further comprising converting the RF power of injected local oscillator signal to produce a direct current for providing power to said DMDM.

24. The method of communicating cellular traffic as set forth in claim 14, further comprising:
injecting, into the signal path, a pilot continuous wave. (CW) frequency as a local oscillator signal, said CW frequency being in a band lower than DBS signals of said DBS network; and
converting the RF power of said local oscillator signal at said DMDM to produce a direct current for providing power to said DMDM.

25. The method of communicating cellular traffic as set forth in claim 18, wherein the CETM amplifies said local oscillator signal in only the direction from said CEEM toward said DMDM.

26. A method of transporting simultaneously cellular signals with multiple air-interface standards and/or multiple providers, carried over different frequency bands, by frequency shifting original cellular signals to frequencies below 950 MHz, and communicating the shifted cellular signals using a DBS network on its non-utilized frequencies below 950 MHz, to standard wireless devices located indoors in the vicinity of a DBS outlet.
